(19) United States
(12) Patent Application Publication
(10) Pub. No.: US 2022/0145080 A1
(43) Pub. Date: May 12, 2022

(54) METHOD FOR PRODUCING ULTRAFINE LIGNIN PARTICLES

(71) Applicant: LIGNOPURE GMBH, Hamburg (DE)

(72) Inventors: Gilda Joana Gil-Chavez, Hamburg (DE); Irina Smirnova, Hamburg (DE); Stefan Heinrich, Hamburg (DE); Ernst-Ulrich Hartge, Hamburg (DE)

(21) Appl. No.: 17/598,302

(22) PCT Filed: Mar. 28, 2019
(86) PCT No.: PCT/EP2019/057892

§ 371 Date: Sep. 27, 2021

(51) Int. Cl. C08L 97/00; B01D 1/18; B01D 1/20

(52) U.S. Cl. CPC C08L 97/005; B01D 1/20; B01D 1/18

(57) ABSTRACT

A method for producing ultrafine lignin particles by means of spray-drying at a dual-fluid nozzle (2), which has a first nozzle opening (31) and a second nozzle opening (41), wherein a lignin-containing solution or suspension is fed to the first nozzle opening (31) of the dual-fluid nozzle (2) and an atomizer gas is fed to the second nozzle opening (41) of the dual-fluid nozzle (2), and wherein: a) the flow rate at which the lignin-containing solution or suspension is fed to the first nozzle opening (31) of the dual-fluid nozzle (2) is 60 to 65 ml/min; b) the drying temperature is 150 to 175° C.; and c) the pressure of the atomizing gas at the second nozzle opening (41) of the dual-fluid nozzle (2) is 3 to 6 bar.

The invention relates to a method for the production of ultrafine lignin particles by means of spray drying.

Biomass becomes increasingly important as a raw material, for example for the production of fuel or indeed as a source of basic and fine chemicals for the chemical industry. In this regard, a major role is played by the comprehensive upgrading of lignocellulose with its main components cellulose, hemicellulose and lignin.

In principle, lignin has a consumer-orientated potential for application as a starting material for phenol production in the raw materials industry, as an adhesive additive, an injection moulding substrate, as a fuel, as a starting material for adsorbents and for insulating materials. In conventional processes (for example what are known as soda or pulping processes), lignin usually occurs as a by-product; lignocellulose is digested with alkalis, acids or organic solvents, or less frequently with steam or aqueous solutions.

In various applications, in particular in the raw material industry, it is advantageous for the lignin to be particulate in form and to have a particle size distribution which is as homogeneous as possible. In previous methods in this regard, it is normally necessary to comminute and mill the lignin in several steps; this is complicated and expensive.

The production of lignin particles and also, for example, of hollow lignin particles by spray drying is known in principle (see U.S. Pat. No. 3,808,192 A; Z.-Z. Pan, L. Dong, W. Lv, D. Zheng, Z. Li, C. Luo, C. Zheng, Q.-H. Yang, F. Kang, 2017, A Hollow Spherical Carbon Derived from the Spray Drying of Corncob Lignin for High-Rate-Performance Supercapacitors, Chem. Asian J. 12, 503; K. Kamegawa, K. Nishikubo, 2014, Hollow carbon microparticles prepared from spray dried particles of lignin in aqueous solution, Carbon 66, 742, doi: 10.1016/j.carbon.2013.09.032).

Other methods are also known by which hollow lignin nanoparticles can be produced (F. Xiong, Y. Han, S. Wang, G. Li, T. Qin, Y. Chen, F. Chu, 2017, Preparation and Formation Mechanism of Renewable Lignin Hollow Nanospheres with a Single Hole by Self-Assembly, ACS Sustainable Chemistry & Engineering 5 (3), 2273-2281, doi: 10.1021/acssuschemeng.6b02585; Beisl, S., Miltner, A., Friedl, A., 2017, Lignin from Micro- to Nanosize: Production Methods, Int. J. Mol. Sci. 18, 1244, doi: 10.3390/ijms18061244).

Gil-Chavez describes a spray drying process in which lignin particles are produced in a single step (Gil-Chavez G. J., 2016, Development of a Lignin Recovery Process Targeting its Formulation and Application into Consumer Goods, In: Book of Abstract, ESS-HPT 2016, The European Summer School in High Pressure Technology, 3.-17.7.2016, 39-41). In the process, a lignin suspension is supplied to a nozzle and spray drying is carried out at a drying temperature in the range 180-200° C., a nozzle pressure in the range 1-1.5 bar and an inflow rate for the lignin suspension of 75-100 mL/min.

There is still a need for improved methods for the production of ultrafine lignin particles.

The present invention provides a method for the production of ultrafine lignin particles by means of spray drying at a dual fluid nozzle with a first nozzle opening and a second nozzle opening, wherein a lignin-containing solution or suspension is supplied to the first nozzle opening of the dual fluid nozzle and an atomizing gas is supplied to the second nozzle opening of the dual fluid nozzle, and wherein:

a) the flow rate at which the lignin-containing solution or suspension is supplied to the first nozzle opening (31) of the dual fluid nozzle is 60 to 65 mL/min;
b) the drying temperature is 150° C. to 175° C.; and
c) the pressure of the atomizing gas at the second nozzle opening of the dual fluid nozzle is 3 to 6 bar.

With the aid of the method in accordance with the invention, it is possible to form lignin particles with a desired size in a single step. Lignin powder produced in accordance with the invention has a comparatively homogeneous composition as regards the particle size distribution. With the method in accordance with the invention, for example, lignin particles can be produced with a particle size distribution of D90: <25 μm, D50: <10 μm and D10: <5 μm. Furthermore, it has surprisingly been established that with the method in accordance with the invention, low density hollow lignin particle bodies can be produced, for example in a size range of 3-15 μm. With the method in accordance with the invention, lignin particles can be obtained with advantageous properties as regards storage and transport as well as for desired applications, for example for use in adhesive compounds as well as in the pharmaceuticals and cosmetics fields. As an example, lignin particles produced in accordance with the invention agglomerate relatively little, which is advantageous for many applications. Furthermore, even water-insoluble lignin can advantageously be spray dried using the method in accordance with the invention. In this regard, water-insoluble lignin can be used in an aqueous suspension, for example.

The term “ultrafine lignin particles” as used here should be understood to mean lignin particles with a mean particle diameter of ≤100 μm, preferably ≤90 μm, ≤80 μm, ≤70 μm, ≤60 μm or ≤50 μm, particularly preferably with a mean particle diameter of ≤40 μm, ≤35 μm, ≤30 μm, ≤25 μm, ≤20 μm or ≤15 μm.

The statement that, for example, a particle size distribution of D90: <25 μm, D50: <10 μm and D10: <5 μm means that 90% of the particles have a mean diameter of <25 μm, 50% of the particles have a mean diameter of <10 μm and 10% have a mean diameter of <5 μm.

When the term “lignin-containing substrate” is used here, this should be understood to mean a material or a mixture of materials which contains lignin. Examples of lignin-containing substrates are wood, straw, bagasse, bran, grass etc. The lignin-containing substrate may also be a substrate which has already been pre-treated, for example waste materials from the sulphate or

Kraft process which is often used in papermaking, or waste from lignin-containing substrates which have been treated with organic-aqueous solvents (Organosolv process). In respect of waste of this type, the terms “alkali lignin” “Organosolv” lignin or in fact hydrolysis lignin are also used. The term “lignin-containing substrate” also includes lignocellulose-containing biomass. This is a material in which lignin is embedded in a matrix formed from hemicelluloses and in particular cellulose. The term “alkali lignin” refers to lignin which is obtained after the treatment of wood at raised temperatures (typically 170° C.) using an alkali, for example NaOH and/or a mixture of NaOH and sodium sulphate (Na₂SO₄).

The term “lignin” denotes a complex polymer produced from aromatic alcohols as monomers which are referred to as monolignols and are essentially linked together via ether groups. Examples of monolignols are phenylpropanoids such as p-coumaryl alcohol, coniferyl alcohol and sinapyl alcohol which may e.g. be methoxylated to varying degrees. Lignin is a component of the secondary cell wall of plants and some algae, where it forms crosslinked macromolecules with molecular weights of more than 5000 u. Different wood or plant types have lignins with differing percentages of monolignols. Lignin from softwood, for example, overwhelmingly contains coniferyl units which have a guajacyl residue (3-methoxy-4-hydroxyphenyl residue), while lignin from hardwood contains different proportions of guajacyl residues and sinapyl units which contain a syringyl residue (3,5-methoxy-4-hydroxyphenyl residue). Lignin from grasses contains all three units.

The term “deodorized lignin” should be understood to mean a lignin in which the proportion of odour-forming compounds has been reduced. Odour-forming compounds are usually volatile organic compounds (VOC) which can be detected olfactorily or by measurements in the gas phase. In particular, the term “VOC” should be understood here to mean volatile organic compounds which already have a high vapour pressure at ambient temperatures and therefore preferentially diffuse out of the substrate into the atmosphere. In particular, the term “VOC” should be understood to mean organic components which have a boiling point of 50-260° C. Examples of VOCs are guajacol and reduced organic sulphur compounds such as dimethyl disulphide and dimethyl trisulphide. A method for deodorizing lignin-containing substrates has been described in DE 1020 14108841 B3, for example.

When the term “supercritical fluid” is used here, also abbreviated to SCF, this term means a fluid substance in a near-critical or supercritical state, i.e. at a temperature and at a pressure which is close to or above the critical points (T_{c} and P_{c}) of the substance. In this state, the liquid phase and gas phase can no longer be distinguished. Thus, in this regard, the term refers to a single-component fluid, i.e. fluids which substantially consist of just one substance, for example CO₂, apart from unavoidable impurities. The term “supercritical fluid mixture” should be understood to mean multi-substance fluids, i.e. mixtures of two or more substances, for example CO₂ and propane, or CO₂ and small proportions of ethanol or water. The term “supercritical CO₂”, abbreviated to “scCO₂”, should be understood to mean supercritical carbon dioxide. The critical point for carbon dioxide is at a temperature of 304.13 K (30.98° C.) and a pressure of 7.375 MPa (73.75 bar). Supercritical carbon dioxide occurs at temperatures and pressures above these points.

The term “Aquasolv solid lignin” or “AS lignin” should be understood here to mean lignin that has undergone a hot water extraction.

The term “hot water extraction”, occasionally also referred to as “hot water hydrolysis” or “thermal hydrolysis”, should be understood to mean a thermal treatment using water at a temperature of ≥100° C. and a pressure above the vapour pressure of water at the respective temperature. Examples are temperatures of 100-250° C. at pressures of 1-50 bar, for example a temperature of 200° C. at a pressure of 30 bar. If the terms “hot water hydrolysis” or “hot water pre-treatment” are also used here, they are used synonymously with the aforementioned term “hot water extraction”.

The terms “flow rate”, “supply rate”, “flow speed” or “supply speed” in relation to the lignin-containing solution or suspension should be understood here to mean the volumetric flow of the lignin-containing solution or suspension in the nozzle direction.

The term “drying temperature” refers to the temperature of the hot gas used for spray drying and which is used for drying the lignin-containing droplets exiting the nozzle. In particular, this term refers to the temperature of the drying gas at the nozzle, i.e. at the exit point for the lignin-containing solution or suspension, so that when the lignin-containing solution or suspension exiting the nozzle is brought into contact with a hot gas having the drying temperature. The hot gas may be a single-component gas or a gas mixture, for example air, CO₂ or N₂.

The term “spray drying” describes a known process in which liquid materials (solutions, suspensions or emulsions) are transformed into the powdered form. During spray drying, the material to be dried is atomized by means of an atomizer and introduced into a hot gas or a stream of hot gas, whereupon it dries into a powder over a short period of time.

The term “enzymatic hydrolysis” should be understood to mean a hydrolysis using a cellulase or a mixture of cellulases. As an example, the enzymatic hydrolysis may be carried out at a temperature of 30-70° C., in particular 45-60° C. or 45-55° C., for example 50° C., and at a pH of 4.5-5.5, preferably 4.8. Cellulases are known to the person skilled in the art (see Kirsch et al. 2011, Enzymatische Hydrolyse von Lignocellulose im Festbettreaktor, Chemie Ingenieur Technik 2011, 83(6), 867-873).

The term “atomization pressure” refers to the pressure of the atomizing gas at the second nozzle opening of the dual fluid nozzle.

The term “dual fluid nozzle” (occasionally also described as a “dual substance nozzle”) refers to a nozzle with at least two separate nozzle openings, wherein a first fluid can be discharged from the first nozzle opening and a second fluid can be discharged from the second nozzle opening.

In this regard, the nozzle openings are disposed with respect to each other in a manner such that, for example, when exiting the first nozzle opening, a first fluid, for example a liquid, can be brought into contact with a stream of a second fluid, for example a pre-compressed gas. As an example, the first nozzle opening of the dual fluid nozzle may be disposed centrally and be concentrically surrounded by an annular second nozzle opening. The term “dual fluid nozzle” should not be construed as being limiting in nature, and so the nozzle may also have more than two nozzle openings, for example three nozzle openings.

The term “lignin-containing microbeads”, occasionally also termed “lignin-containing microspheres”, should be understood here to mean lignin containing generally spherical particles with a mean particle diameter of 300 μm to 5 mm, in particular a mean particle diameter of 300 μm to 1.5 mm.

Ranges such as “300 μm to 5 mm” should be understood here to mean that every intermediate value is also disclosed therewith. In addition, any smaller range from the range is also disclosed along with this, wherein the term “smaller range” should also be understood to include ranges which do not include any of the boundary values for the range. Thus, a range such as “300 μm to 5 mm” not only comprises ranges of “300 μm to 4 mm” or “400 μm to 5 mm”, but, for example, also includes ranges of “800 μm to 1.5 mm” or “2 mm to 4 mm”, wherein the individual values within the range are expressly encompassed, and not simply the boundary values.

In the method in accordance with the invention, a lignin-containing solution or suspension is conveyed through a first nozzle opening of a dual fluid nozzle and on exiting the first nozzle opening, it is impacted by a pressurized atomizing gas from the second nozzle opening, whereupon the solution or suspension is atomized into individual droplets. The droplets are dried within a few seconds, for example within 3-10 seconds, by means of a hot gas at a suitable temperature, whereupon lignin particles of a desired size are formed. In this regard, the drying temperature is 150° C. to 175° C., preferably 150° C. to 170° C., the atomization pressure, i.e. the pressure of the atomizing gas at the second nozzle oxygen of the dual fluid nozzle, is 3 to 6 bar and the flow rate of the lignin-containing solution or suspension is 60 to 65 mL/min.

In a preferred embodiment of the method in accordance with the invention, the diameter of the first nozzle opening of the dual fluid nozzle is 1 to 2 mm, preferably 1.5 to 2 mm.

The pressure of the atomizing gas at the second nozzle opening of the dual fluid nozzle is preferably 3 to 5.5 bar, preferably 3 to 5 bar or 3 to 4.5 bar, particularly preferably 3 to 4 bar.

In a particularly preferred embodiment of the method in accordance with the invention, the lignin-containing solution or suspension is a solution or suspension of lignin which is produced from a lignin-containing substrate which has undergone a hot water extraction. A lignin which has been pre-treated in this manner is also occasionally referred to as AS lignin here. The hot water extraction may, for example, be carried out using pure water in a temperature range of 100-250° C., for example 200° C., and at pressures of 1-50 bar, for example 30 bar. The hot water extraction may be carried out in one stage or in several stages, for example with stepwise increasing temperatures and increasing pressures. Preferably, the ratio of water to lignin-containing substrate is 5-10:1. In the case of a fixed bed method which is preferred in this case, the hot water flows through the lignin substrate, preferably counter to the gravitational direction.

More preferably, the lignin-containing solution or suspension is a solution or suspension of lignin which is produced from a lignin-containing substrate which has undergone a hot water extraction and a subsequent enzymatic hydrolysis using cellulase(s). A particularly suitable pre-treatment method has been described, for example, in DE 1020 14108841 B3.

In the method in accordance with the invention, it is also possible to use a deodorized lignin. However, this is not necessary. In this regard, a lignin which has been pre-treated by means of hot water extraction and enzymatic hydrolysis undergoes an extraction with a supercritical fluid, for example with supercritical carbon dioxide, as described in DE 1020 14108841 B3.

The solids content of the lignin solution or lignin suspension is preferably 5 to 20% by weight.

The lignin may be dissolved, partially dissolved or suspended in any suitable solvent. However, preferably, the lignin is dissolved or suspended, preferably suspended, in water.

In a preferred embodiment of the method in accordance with the invention, the lignin-containing solution or suspension is injected through the nozzle into a drying chamber which contains a hot drying gas. In this embodiment, the droplets of the lignin-containing solution or suspension which are formed by means of the atomizing gas upon exiting the nozzle reach a chamber with a hot gas, for example air or gaseous nitrogen. In the chamber, the solvent, for example water, evaporates off and dry lignin particles are formed. The chamber may be configured such that different particle fractions, for example particle size fractions, can be removed separately from the chamber. As an example, on the bottom of the chamber, an extraction point may be provided for coarser particles, while finer particles could be extracted via a lateral wall of the chamber at one or more specified heights.

Preferably, the hot drying gas is fed into the drying chamber as a co-current with the lignin-containing solution or suspension. In this embodiment, the hot drying gas is fed into the drying chamber, for example at an inlet temperature of 150° C. to 175° C., and brought into contact with the fine droplets formed at the nozzle. The expression “as a co-current” as used here means that the drying gas is fed into the drying chamber in substantially the same direction as the lignin-containing solution or suspension, so that the particle flow and the flow of the drying gas are in the same direction in the drying chamber.

In the method in accordance with the invention, the lignin-containing solution or suspension is fed through one nozzle opening of the dual fluid nozzle, while at the same time, the atomizing gas, for example nitrogen, CO₂ or air, is fed through the second nozzle opening. The volumetric flows of both fluids may be controlled separately and be matched to each other.

Preferably, the dual fluid nozzle has a central first nozzle opening and an annular second nozzle opening which concentrically surrounds the central nozzle opening. In this configuration, more preferably, the lignin-containing solution or suspension is supplied to the central first nozzle opening of the dual fluid nozzle, while the second nozzle opening is supplied with the pressurized atomizing gas, preferably air, CO₂ or nitrogen. In this embodiment, the lignin-containing solution or suspension, which is preferably an aqueous solution or suspension of AS lignin, is supplied to the central nozzle opening of the dual fluid nozzle, while at the same time a stream of atomizing gas, for example nitrogen gas, CO₂, air or another suitable single or multi-component gas, flows out of the second nozzle opening which concentrically surrounds the first nozzle opening. The droplets of lignin-containing solution or suspension which are formed upon exiting the first nozzle opening of the nozzle are dried by the flow of hot gas which preferably flows as a co-current with the lignin-containing solution or suspension within a short period of time, for example within 3-10 seconds, i.e. the solvent, preferably water, is evaporated off by means of the hot gas.

The lignin particles which are formed often have an advantageous hollow structure, i.e. they are hollow inside with an outer wall of lignin. Without wishing to be bound by any particular theory, it is assumed that initially, the solvent evaporates in the superficial regions of the droplets which are formed, whereupon initially a comparatively solid lignin wall is formed there. Next, via this lignin wall, more solvent evaporates from the interior of the droplet, whereupon more lignin is transported to the lignin wall and is deposited there. Hollow lignin particles of this type are particularly advantageous for use, for example, as an additive in adhesive compounds and in pharmaceutical or cosmetic products.

In a further aspect, the invention also concerns lignin-containing microbeads which contain the ultrafine lignin-containing particles produced in accordance with the invention as well as at least one binder.

Preferably, the lignin-containing microbeads comprise ultrafine lignin-containing particles which are produced from Aquasolv lignin (AS lignin). The AS lignin particles are produced using the method in accordance with the invention from AS lignin, i.e. lignin which has been produced from a lignin-containing substrate, for example straw, by means of a thermal treatment with hot (for example 200° C.) pressurized liquid water, and preferably a subsequent enzymatic hydrolysis using cellulase(s).

Suitable binders are known to the person skilled in the art. Preferably, the binder is a gel-forming biopolymer. As an example, AS lignin may be used in combination with one or more gel-forming biopolymers, for example alginate, cellulose, pectin, chitosan, starch, polylactide (PLA) or silicates, as well as proteins such as zein, whey proteins and others. The gelling of lignin in combination with another biopolymer is preferably carried out in the presence of a crosslinking molecule. Depending on the formulation of the AS lignin and binder, gel formation may occur at low temperatures (for example −6° C., 0° C.), high temperatures (80-140° C.), in an acidic (pH <6) or in a basic (pH >7) environment.

The mass fraction of lignin in the formulation may be 10 to 90% by weight, preferably 30 to 90% by weight, for example 30% by weight, 50% by weight, 70% by weight or 90% by weight. In the case of gel formation with crosslinking with the aid of a crosslinking molecule, the mass fraction is relative to the formulation of the AS lignin and binder prior to crosslinking Microbeads from lignin formulations such as lignin-alginate, lignin-pectin, lignin-chitosan, lignin-cellulose, lignin-starch and lignin-protein can be used in foodstuffs, in pharmaceuticals and in cosmetic products. Microbeads from lignin formulations such as, for example, lignin-starch, lignin-cellulose, lignin-silicate, may be used in construction materials. Microbeads of the lignin-silicate lignin formulation may also be used in cosmetics applications. Microbeads from formulations such as lignin-polylactide, lignin-polylactide-silicate, may be used for construction materials, packaging materials or biocomposites. Examples of cosmetics applications are peeling products for body care, face masks, soap, facial peeling products and toothpastes. Examples of applications of the microbeads in accordance with the invention in foodstuffs are their use as an active ingredient in functional foodstuffs, as a support for antioxidants, flavourings, vitamins, etc.

The mean particle diameter for the microbeads may, for example, be 300 μm to 5 mm Preferably, the mean particle diameter is 300 μm to 1.5 mm. For use in the cosmetic field, preferably, the mean particle diameter for the microbeads is 300 to 800 μm. For other applications, it may be advantageous for the mean particle diameter of the microbeads to be 400 μm to 1.5 mm, for example.

The invention will now be described in more detail with reference to the accompanying figures and exemplary embodiments, for the purposes of illustration only.

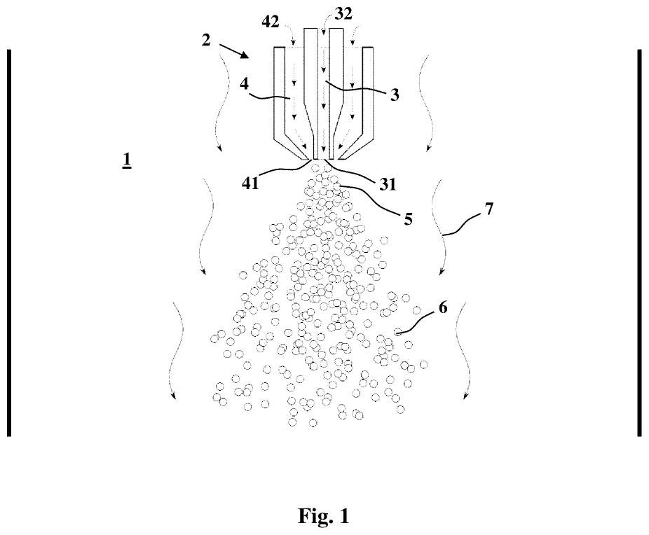

FIG. 1. Schematic of part of a device with which a preferred embodiment of the method in accordance with the invention can be carried out.

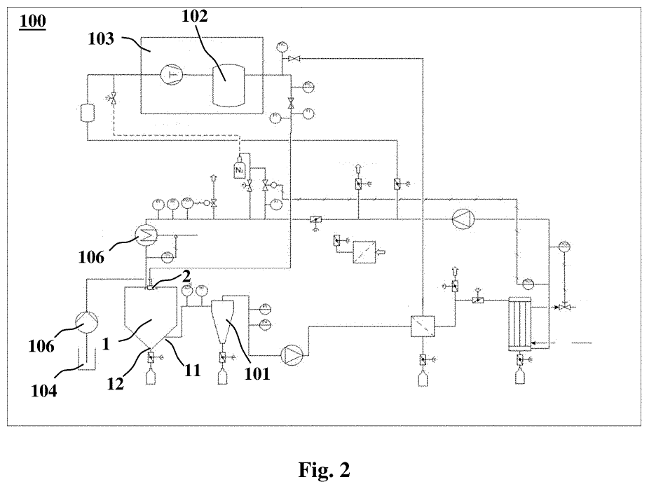

FIG. 2. A simplified flowchart for a device for carrying out an embodiment of the method in accordance with the invention.

FIG. 3. Particle size distribution of AS lignin particles obtained with two different nozzles (1.5 and 2 mm opening diameter).

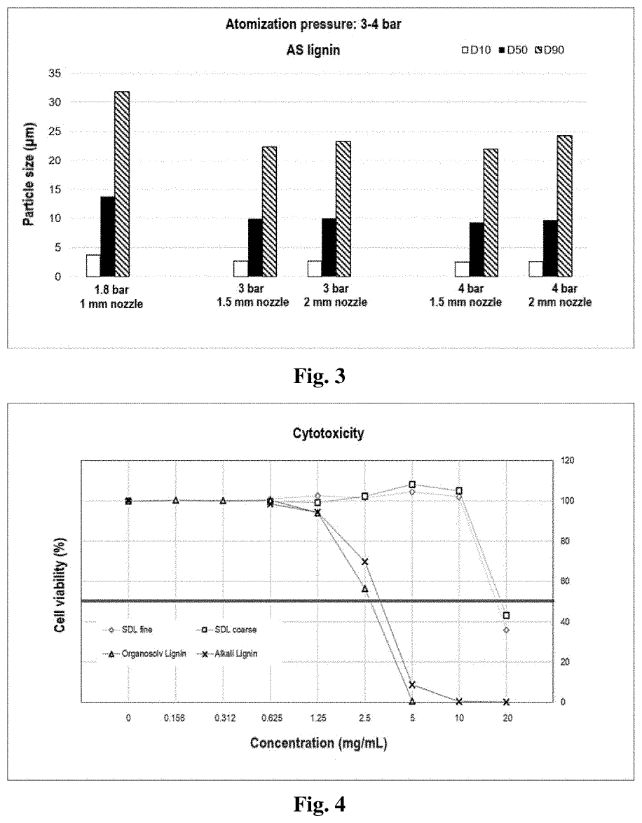

FIG. 4. Cytotoxicity of spray dried lignin (fine fraction=SDL fine; coarse fraction=SDL coarse) compared with Organosolv and alkali lignin.

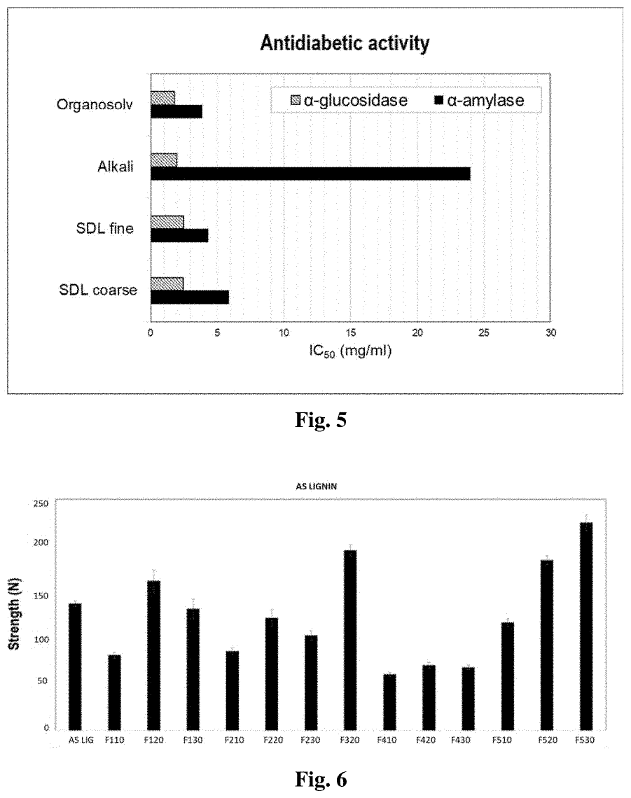

FIG. 5. IC50 values for different lignins for the inhibition of α-glucosidase and α-amylase. Fine fraction=SDL fine; coarse fraction=SDL coarse.

FIG. 6. Hardness of tablets obtained by direct compression of AS lignin with different excipients: F1 (alginate) F2 (starch), F3 (direct compression-excipient, DCE), F4 (microcrystalline cellulose, MCC), F5 (lactose), in various concentrations: 10%, 20% and 30% by weight.

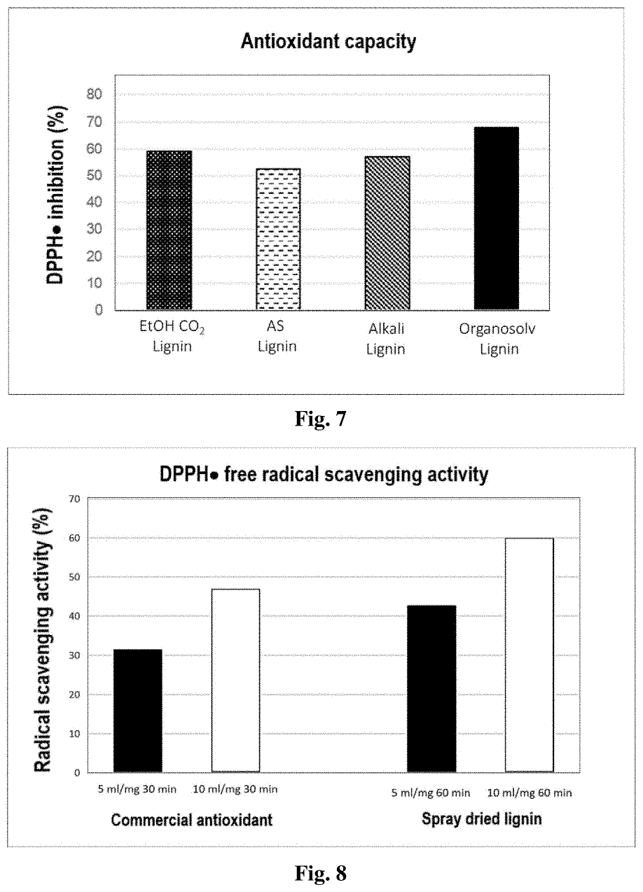

FIG. 7. Radical scavenger capacity (% inhibition) of spray dried lignin and lignins in accordance with the invention which have been obtained by other biorefining processes. EtOH=ethanol; Organosolv-lignin=lignin extracted with ethanol (produced by Fraunhofer CBP Leuna); EtOH CO₂=lignin particles which have undergone a solvent exchange (exchange of water to ethanol), wherein the ethanol was then extracted with supercritical CO₂.

FIG. 8. DPPH radical scavenger activity for two antioxidants: spray dried lignin particles and Tesa antioxidant compound from a brand manufacturer of adhesive film.

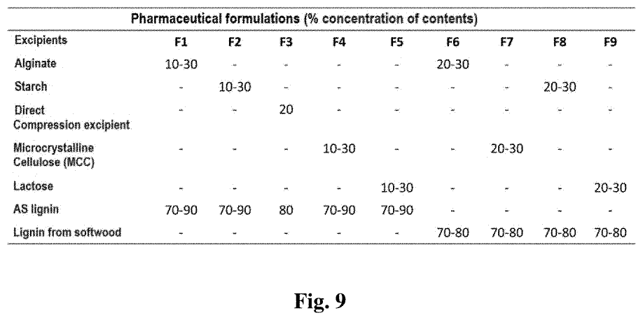

FIG. 9. Composition of nine different lignin fillers at different excipient concentrations.

AS lignin particles with appropriate properties were produced by means of spray drying. Regarding the particle size distribution, homogeneous lignin powder with the desired properties could be produced in a single step using the method in accordance with the invention. The multiple comminution and milling steps which had been required until now can be dispensed with.

FIGS. 1 and 2 concern diagrammatic representations of a device which was used for the production of lignin particles 6 from AS lignin suspensions. FIG. 1 diagrammatically shows the spray drying process using a dual fluid nozzle 2 as part of the unit 100 employed for the test. FIG. 2 shows a simplified flow diagram for the unit 100 for the production of AS lignin particles.

The spray drying method in accordance with the invention encompasses the production of a lignin powder by drying a liquid solution or suspension with a hot drying gas. In the tests described here, nitrogen (N₂) was used. AS lignin suspended in water was used as the lignin material; it had undergone a cellulase treatment following a hot water extraction. During the spray drying process, the liquid lignin-containing material (solution or suspension) was atomized and brought into contact with a stream of hot gas. To this end, a dual fluid nozzle 2 was used; this is shown in longitudinal section. The dual fluid nozzle 2 comprises a central bore 3 with a central first nozzle opening 31 to a drying chamber 1 and a bore 4 which concentrically surrounds the central bore 3 with a second nozzle opening 41 to the drying chamber 1 which concentrically surrounds the first nozzle opening 31. The liquid AS lignin-containing material was fed via a first inlet opening 32 through the central bore 3 to the central first nozzle opening 31 (arrows with solid lines), the atomizing gas, in this case N₂, was fed via a second inlet opening 42 through the concentric bore 4 to the second nozzle opening 41 (arrow with dotted lines). The hot gas, in this case also N₂, was thus fed into the drying chamber 1 in a manner such that the hot gas stream 7 ran as a co-current to the stream of particles which had been formed. In this manner, the hot gas was introduced into the drying chamber 1 in the immediate vicinity of the dual fluid nozzle 2. The hot gas stream 7 and the stream of particles ran essentially in the gravitational direction. The contact between the material to be dried and the hot gas in the drying chamber 1 is brief but sufficient to carry out evaporation of the water within the atomized droplets 5. The atomization was obtained pneumatically by means of a high speed of the compressed atomizing gas in contact with the liquid lignin material (droplet formation), as can be seen in simplified manner in FIG. 1.

The morphology and particle size of the final product can be controlled by varying the ratio of the flow rates between the starting material (lignin suspension or solution) and the pressurized atomizing gas at the respective nozzle openings 31, 41 as well as the inlet and outlet temperatures in the drying chamber 1. The mode of obtaining the dried lignin particles 6 may vary as a function of the configuration of the spray drying unit 100. In the tests described here, a spray drying unit with a drying chamber 1 was used which was equipped with two extraction points 11, 12 (see FIG. 2). Coarse (larger and heavier) particles 6 (coarse fraction) could be collected through a bottom first extraction point 12; finer particles 6 (fine fraction) could be collected through the laterally disposed second extraction point 11. A fraction with finer lignin particles 6 could be transferred via the lateral extraction point 11 to a cyclone 101 for further separation. The AS lignin suspension was held in a storage container 104 and supplied by means of a pump 105 to the first (central) bore 3 of the dual fluid nozzle 2. The atomizing gas, in this case N₂, was held in a tank 102 and supplied to the nozzle 2 by means of a compressor unit 103. The hot gas, in this case also N₂, was heated to the desired temperature by means of a heater 106 and fed into the drying chamber 1 close to the nozzle 2.

In order to spray dry AS lignin, in the configuration shown here with a dual fluid nozzle, the following three parameters were varied:

1. The inlet temperature of the hot gas, which corresponded to the temperature of the hot gas (N₂) at the dual fluid nozzle 2 because the hot gas was introduced in the immediate vicinity of the dual fluid nozzle 2.
2. The pressure of the atomizing gas at the second nozzle opening 31 of the dual fluid nozzle 2 (also referred to as the “atomization pressure”).
3. The flow rate at which the lignin-containing solution or suspension was supplied to the first nozzle opening 31 of the dual fluid nozzle 2.

An AS lignin suspension with a solid content of 5% to 20% by weight was used. The AS lignin was produced by thermal hydrolysis and subsequent enzymatic hydrolysis, in which liquid water at approximately 200° C. and under pressure was forced through straw and the suspension produced was supplemented with cellulases. The diameter of the nozzle opening 31 was 1-2 mm. In this configuration, the inlet temperature for the hot gas controlled the temperature in the drying chamber 1.

The formation of ultrafine lignin particles and of hollow ultrafine lignin particles was obtained at an inlet temperature for the hot gas of 150-175° C., 3-6 bar atomization pressure and a flow rate for the AS lignin suspension of 60-65 mL/min. Ultrafine particles with a size range of 3-15 μm could be formed using the method in accordance with the invention.

Surprisingly, tests have shown that spray dried lignin particles 6 produced in accordance with the invention exhibited a substantially smaller agglomeration compared with milled particles. The reason for this could be the disposition of hydrophobic lignin sites on the outer particle layer which prevents binding or interaction of particle surfaces with each other. These results are of great significance for applications in adhesive compounds for adhesive tapes, because the agglomeration can lead to dark spots in the adhesive tape, which is not desirable.

As an example, hollow particles can be used for the controlled release of drugs, chemical reagents and cosmetics from the interior of the hollow particles via the surface. For many pharmaceutical applications, the low density of the hollow lignin particles is advantageous.

Regarding the particle sizes obtained with the method in accordance with the invention, in the case of nozzle openings of 1.5-2 mm, a D50 value of <10 μm and a D10 value of <5 μm was obtained (see FIG. 3). It is of particular note that furthermore, a D90 value of <25 μm (see FIG. 3) could be obtained, which means that all the particles added to adhesive compounds have sizes below 30 The water content of the lignin powder obtained was 1.5% to 5% by weight.

### Cytotoxicity

The viability of cells of a CaCo-2 cell culture which had been incubated at various concentrations with lignin from a variety of origins (particles in accordance with the invention (SDL) of the coarse (SDL coarse) and fine fractions (SDL fine), Organosolv lignin and alkali lignin) was measured (see FIG. 4). It can be seen that in the case of Organosolv and alkali lignin, a concentration of approximately 2.5 mg/mL was sufficient to kill 50% of the cells, while spray dried lignin required a concentration which was almost 10 times higher to obtain the same effect.

### Anti-Diabetic Action

The activity of the enzymes α-glucosidase and α-amylase at different lignin concentrations was investigated. These enzymes are responsible for the degradation of complex high molecular weight carbohydrates and produce sugar monomers which are readily available for absorption in the human body. It was assumed that compounds which could inhibit the activity of these enzymes have an anti-diabetic action when consumed. FIG. 5 shows IC50 values (effective concentration for inhibition of the activity of the enzyme by 50%) for lignin particles produced in accordance with the invention (fine fraction and coarse fraction) compared with those for Organosolv and alkali lignin particles. In this case, lower values indicated a larger expected anti-diabetic action. Lignin particles produced in accordance with the invention exhibit a comparatively high anti-diabetic action.

### Tabletting Lignin Particles

Lignin is a known alternative to activated carbon. The behaviour of the pharmaceutical forms, however, is strongly dependent on the particle properties and the compression behaviour. Thus, direct compression of the lignin particles obtained by the method in accordance with the invention was compared with known pharmaceutical excipients.

The tested formulations are shown in FIG. 9: alginate, starch, microcrystalline cellulose (MCC), lactose and a direct compression excipient (DCE) were used in various concentrations. The spray dried AS lignin in accordance with the invention was compared with a medical lignin (“softwood lignin”) which was used for the production of a lignin-based medical tablet.

FIG. 6 shows the hardness of the various compositions based on AS lignin given in FIG. 9. In general, the hardness of the tablets increased with the addition of excipients. Despite this, the desired hardness depends on the release behaviour of the tablet. According to the USP Pharmacopoeia, tablet dosage forms should have a friability (fracture behaviour) of less than 5%. In the case of the spray dried AS lignin in accordance with the invention, they all complied with this specification.

### DPPH Measurement

The antioxidant potential of the spray dried lignin was measured using the DPPH radical method. DPPH (2,2-diphenyl-1-picrylhydrazyl) is violet in its active radical form and discolours to yellow when it is stabilized by radical scavengers/antioxidants. In order to compare the radical scavenging capacity of spray dried lignin in accordance with the invention, various lignins were used (see FIG. 7). In general, a high molecular weight lignin is linked to a low antioxidizing potential compared with other biorefining methods. The spray dried lignin in accordance with the invention, however, exhibited similar results to that of low molecular weight lignins, possibly because of a large contact surface area which is formed by employing this method.

Incorporation into Adhesive Compounds

Spray dried fine lignin produced in accordance with the invention was incorporated into adhesive compounds. The appearance of kneaded samples was evaluated. The samples contained lignin which had been obtained by a variety of methods, and lignin from different biomass sources. The adhesive films, which contained ultrafine spray dried lignin particles produced in accordance with the invention, exhibited the most similar behaviour to calcium carbonate, which is a frequently used standard filler.

Application of Spray Dried Lignin in Accordance with the Invention to Adhesive Films

Two concentrations of antioxidants (standard agents from a brand manufacturer of adhesive films and fine lignin particles produced in accordance with the invention) were tested at two different reaction times: 5 mg/mL and 10 mg/mL at 30 and 60 min. the results are shown in FIG. 8. It can be seen that lignin particles produced in accordance with the invention at both concentrations have a clear advantage over the antioxidants used by Tesa at least at these reaction times.

### Production of AS Lignin-Based Microbeads (“Microbeads”)

Lignin-based microbeads (“microbeads”) in accordance with the invention were produced using lignin-containing particles produced using the method in accordance with the invention. To this end, stock solutions or stock suspensions were produced which contained AS lignin particles in combination with gel-forming biopolymers (alginate, cellulose, pectin, chitosan, starch, polylactide). The gel-forming biopolymers were mixed in water (deionized or distilled, occasionally heated), acidic or alkaline media to a proportion by weight of 1% by weight, 2% by weight, 3% by weight, 4% by weight and 5% by weight. The mixture of biopolymer solution and AS lignin particles could contain a proportion of 10-90% by weight of lignin. The mixture was carefully and thoroughly mixed until a homogeneous solution/suspension was obtained.

Microparticles were produced from the stock solutions/suspensions by means of a Type S jet cutter (geniaLab GmbH, Braunschweig, Germany). To this end, particles were produced from a stream of fluid which exited from a nozzle under pressure, wherein the full stream exiting the nozzle is cut by means of a rotating cutter tool produced from radially disposed cutting wires into identically shaped cylindrical segments. Because of surface tension, while they fall under gravity, the fluid segments form spherical droplets with a uniform size. The size of the droplets may, for example, be adjusted via the speed of rotation of the cutter tool, the diameter and the volumetric flow rate of the stream of liquid. The droplets produced in this manner fall into a crosslinking/curing solution. The nozzle was driven by compressed air (1-3 bar) which was adjusted by means of a pressure regulation valve or via pumps.

The production of microparticles (“microbeads”) was, for example, carried out using the following parameters: flow rate of stock solution/suspension in the range 0.5 to 10 g/s, nozzle diameter from 200 μm to 5 mm. The separating disks could, for example, contain 16 to 180 wires with a wire thickness of 100 μm to 500 μm.

The crosslinking solution could comprise calcium chloride, ethanol, acetic acid, aqueous acidic solutions or aqueous basic solutions, for example. The distance between the nozzle and the gelling bath was maintained in the range from approximately 50 to 100 cm. The volume in the crosslinking bath was at least four times the total volume of the processed biopolymer solution/suspension, in order to prevent agglomeration of the microbeads. After jet cutting was complete, the contents of the collecting baths were stirred until the particles had been removed. Gelled particles were separated from the gelling/crosslinking bath by screening and/or filtration. The separated microparticles could be dried at ambient temperature, oven dried or supercritically dried.

1. A method for the production of ultrafine lignin particles (6) by means of spray drying at a dual fluid nozzle (2) with a first nozzle opening (31) and a second nozzle opening (41), wherein a lignin-containing solution or suspension is supplied to the first nozzle opening (31) of the dual fluid nozzle (2) and an atomizing gas is supplied to the second nozzle opening (41) of the dual fluid nozzle (2), and wherein:
a) the flow rate at which the lignin-containing solution or suspension is supplied to the first nozzle opening (31) of the dual fluid nozzle (2) is 60 to 65 mL/min;
b) the drying temperature is 150° C. to 175° C.; and
c) the pressure of the atomizing gas at the second nozzle opening (41) of the dual fluid nozzle (2) is 3 to 6 bar.

2. The method as claimed in claim 1, wherein the diameter of the first nozzle opening (31) of the dual fluid nozzle (2) is 1 to 2 mm, preferably 1.5 to 2 mm.

3. The method as claimed in claim 1, wherein the lignin-containing solution or suspension is a solution or suspension of lignin which has undergone a hot water extraction.

4. The method as claimed in claim 3, wherein the lignin-containing solution or suspension is a solution or suspension of lignin, which has undergone an enzymatic hydrolysis using cellulase following the hot water extraction.

5. The method as claimed in claim 1, wherein the solids content of the lignin solution or suspension is 5% to 20% by weight.

6. The method as claimed in claim 1, wherein the lignin-containing solution or suspension is an aqueous solution or suspension, preferably an aqueous suspension.

7. The method as claimed in claim 1, wherein the lignin-containing solution or suspension is injected through the first nozzle opening (31) of the dual fluid nozzle (2) into a drying chamber (1) which contains a hot drying gas, preferably air, CO₂ or nitrogen gas.

8. The method as claimed in claim 7, wherein the hot drying gas is fed into the drying chamber (1) as a co-current with the lignin-containing solution or suspension.

9. The method as claimed in claim 1, wherein the first nozzle opening (31) of the dual fluid nozzle (2) is centrally disposed and the second nozzle opening (41) is annular and concentrically surrounds the central first nozzle opening (31), and wherein the lignin-containing solution or suspension is supplied to the central first nozzle opening (31) of the dual fluid nozzle (2) and the second nozzle opening (41) is supplied with a pressurized atomizing gas, preferably air, CO₂ or nitrogen.

10. The method as claimed in claim 1, wherein the pressure of the atomizing gas at the second nozzle opening (41) of the dual fluid nozzle (2) is 3 to 5.5 bar, preferably 3 to 5 bar or 3 to 4.5 bar, particularly preferably 3 to 4 bar.

11. Lignin-containing microbeads, comprising a) a plurality of ultrafine lignin-containing particles which are produced by means of the method as claimed claim 1, and b) at least one binder.

12. The lignin-containing microbeads as claimed in claim 11, wherein the ultrafine lignin-containing particles are produced from AS lignin.

13. The lignin-containing microbeads as claimed in claim 11, wherein the binder is a gel-forming biopolymer, preferably alginate, cellulose, pectin, chitosan, polylactide or starch, or silicate or protein.

14. The lignin-containing microbeads as claimed in claim 11, wherein the proportion of lignin in the microbeads is 10-90% by weight, preferably 30-90% by weight.

15. The lignin-containing microbeads as claimed in claim 11, wherein the mean particle diameter of the microbeads is 300 μm to 5 mm, preferably 300 μm to 1.5 mm.
